(19) United States
(12) Patent Application Publication
(10) Pub. No.: US 2026/0178870 A1
(43) Pub. Date: Jun. 25, 2026

(54) ANTENNA FOR USE IN AN RFID TAG

(71) Applicant: NV BEKAERT SA, Zwevegem (BE)

(72) Inventors: Dominique ANDRIES, Oudenaarde (BE); Benjamin DE SCHEPPER, Zwevegem (BE)

(73) Assignee: NV BEKAERT SA, Zwevegem (BE)

(21) Appl. No.: 19/128,660

(22) PCT Filed: Dec. 11, 2023
(86) PCT No.: PCT/EP2023/085204

§ 371 Date: May 9, 2025

(30) Foreign Application Priority Data
Dec. 13, 2022 (EP) 22213246.6

(51) Int. Cl. G06K 19/077; G06K 19/02

(52) U.S. Cl. CPC G06K 19/07764; G06K 19/027; G06K 19/07786

(57) ABSTRACT

Antenna for use in an RFID tag, said antenna having a core, a metal wire or cable, and a protective sleeve, wherein said core contains textile made from polymer or organic materials, said metal wire or cable is spiralled or helixed around said antenna core in Z or S direction to form a composite structure, and said protective sleeve is made by one or more wrapped layers around said composite structure, and said protective sleeve contains textile made from polymer or organic materials.

### TECHNICAL FIELD

The invention relates to the field of antennas suitable for use in RFID (Radio Frequency Identification) tags. The invention further relates to RFID tags comprising such antennas, RFID tags that can be attached to objects, e.g., laundry items, for instance clothing and bed sheets used in hospitals or hotels, or e.g. pneumatic rubber tires for a motorized vehicle at various locations.

### BACKGROUND ART

WO2014/204322A1 discloses an RFID tag particularly suitable for use as linen or laundry tag. The RFID tag in a specific embodiment comprises a backing layer, a first adhesive layer overlaying the backing layer, an RFID transponder chip and an antenna overlaying the first adhesive layer, and a second adhesive layer overlaying the RFID transponder chip and the antenna. The layers are laminated together, hermetically sealing the RFID transponder chip and antenna within the RFID tag. In a preferred embodiment, the antenna comprises an elongated multi-strand stainless steel wire, e.g., having 49 strands. The wire is preferably between 0.3 and 0.5 mm in diameter and encapsulated in a nylon or other polymer insulation. It is mentioned that such a multi-strand wire structure measuring 0.3-0.5 mm in diameter with 49 strands was found to have sufficient flexibility and was less prone to kinking than prior art antennas. The antenna can be stitched to a reinforced adhesive layer prior to lamination. The stitching may comprise a cotton, polyester-cotton, or other substantially durable thread, and preferably holds the antenna in position during lamination and, in combination with the reinforced adhesive layer, during subsequent use of the RFID tag.

WO2017/060222A1 discloses a RFID tag and in particular to an antenna for use in an RFID tag. The antenna comprises an antenna yarn made from metal fibers. The metal fibers are Stainless steel fibers. The antenna yarn is wrapped by at least one wrapping yarn thereby covering the full surface of the antenna yarn or of the metal wire or of the bundle of metal wires. The at least one wrapping yarn comprises non-electrically conductive fibers.

It has been found that RFID antenna wires can crack under various stresses due to incompatibility between antenna wire and the embedded system. These embedded systems do not allow the antenna to move freely when undergoing stresses, therefore antennas receive a huge amount of stress. This can result in breaking or failure of the RFID tag and render the RFID tag not workable or unusable.

### DISCLOSURE OF INVENTION

It is an objective of the invention to provide an improved RFID antenna with a high durability.

It is a specific objective of the invention to provide an improved RFID antenna that provides desired properties in embedded RFID systems. Herein, the embedding systems can be rubber, epoxy, composite, or other casings.

According to a first aspect of the invention, it is provided an antenna for use in an RFID tag. The antenna comprises a core, a metal wire or cable, and a protective sleeve, wherein said core comprises, and preferably consists of, textile made from polymer or organic materials,
said metal wire or cable is spiralled or helixed around said antenna core in Z or S direction to form a composite structure,
said protective sleeve is made by one or more wrapped layers around said composite structure, and
said protective sleeve comprises, and preferably consists of, textile made from polymer or organic materials.

According to the invention, the textile of the core or the protective sleeve can be in a form of yarns, wires, multifilament, or monofilaments. The core or the protective sleeve comprise polymer selected from polyester, polyamide, polyimide, (para- or meta-) aramid, Liquid Crystal Polymer (LCP) or materials under the trademark of Kevlar®, Vectran®, Taparan®. Alternatively, the core or the protective sleeve comprise organic materials selected from cotton or hemp. The textile core has an equivalent diameter in a range from 0.10 mm to 0.30 mm and has a linear density in a range from 110 dtex to 2000 dtex. Preferably, the textile core is present as filaments in parallel untwisted arrangement. It is meant that that no twisting nor cabling operation has been applied to the filaments, such that the filaments lie substantially parallel to each other and substantially parallel to the axis of the antenna yarn. Because of the lower bending stiffness of such core, it absorbs better the stresses the final product can undergo.

The metal wire or cable can be made from stainless steel, etched copper, or aluminium. Preferably, the metal wire or cable is made from stainless steel fibers—e.g., stainless steel filaments-have an equivalent diameter of less than 20 μm, preferably of less than 15 μm; e.g. 14 μm or 12 μm. The equivalent diameter of a fiber of non-circular cross section is the diameter of a circle with the same area as the area of the cross section of the fiber that has a non-circular cross section. Preferably, the metal wire comprises or consists out of stainless steel filaments; twisted with a twist less than 200 turns per meter, more preferably less than 150 turns per meter, even more preferably with a twist less than 120 turns per meter. As an example, the metal cable is made from a plurality of monofilaments with a diameter of more than 25 μm, or from a bundle of ultrafine wires with a diameter less than 25 μm, i.e., the individual wires have a diameter less than 25 μm. For instance, the metal cable can be a bundle of 275 stainless steel filaments of 12 μm diameter, twisted with 100 turns per meter length of the antenna yarn.

Preferred stainless steel fibers, are manufactured via the bundle drawing method. The stainless steel fibers can be present as filaments (with filaments is meant fibers of virtually unlimited length); or the stainless steel fibers can be present as fibers of discrete length. Preferably, the stainless steel fibers have a polygonal, more preferably a hexagonal, cross section.

Preferably, the stainless steel fibers-whether fibers of discrete length or filaments-have an equivalent diameter of less than 20 μm, preferably of less than 15 μm; e.g. 14 μm or 12 μm. Preferably, the stainless steel fibers-whether fibers of discrete length or filaments-are produced via the bundle drawing process, resulting in a typical polygonal cross section of the stainless steel fibers or filaments.

Preferably, the stainless steel fibers have a martensite percentage by weight less than 5%, preferably less than 3%, more preferably less than 2%, more preferably less than 1%, more preferably below 0.35%, more preferably below 0.25%, more preferably below 0.1%. Even more preferably, the stainless steel fibers are free from martensite.

For the invention, with stainless steel is meant a steel grade comprising at least 10.5% by weight of chromium. Preferably, the stainless steel is stainless steel of the 300 series or of the 200 series according to ASTM A240, e.g., alloy 316 or alloy 316L. Preferably, the stainless steel fibers are made out of an alloy comprising at least 12 % by weight of nickel and at least 16 % by weight of chromium; and preferably between 2 and 2.5 % by weight of molybdenum. Even more preferred is an alloy that has the same specification as alloy 316L but with modified nickel content (between 12 and 15 % by weight), modified chromium content (between 17 and 18 % by weight) and modified molybdenum content (between 2 and 2.5 % by weight).

Preferably, the stainless steel fibers are out of a stainless steel alloy comprising between 12 and 15% by weight of nickel, between 17 and 18% by weight of chromium, between 2 and 2.5% by weight of molybdenum, less than 0.03 % by weight of carbon and less than 0.1% by weight of nitrogen. Such alloy is preferred because of its low amount of martensite in the end-drawn microstructure of bundle drawn fibers.

Preferably, the stainless steel fibers comprise or are made out of a high nitrogen austenitic stainless steel (HNASS). A high nitrogen austenitic stainless steel alloy is a stainless steel alloy comprising nitrogen content of more than 0.4% by weight. HNASS steel grades stay fully austenitic during the wire drawing or bundled fiber drawing process; no strain induced martensite is formed during the drawing process.

A first example of a HNASS steel grade that can be used in the invention comprises 0.2 % by weight of carbon, 17% by weight of chromium, 0.05 % by weight of nickel, 0.53% by weight of nitrogen, 3.3% by weight of molybdenum and 10.50% by weight of manganese.

A second example of a HNASS steel grade that can be used in the invention comprises 0.08% by weight of carbon, 21 % by weight of chromium, 0.3% by weight of nickel, 1% by weight of nitrogen, 0.7% by weight of molybdenum and 23% by weight of manganese.

The stainless steel fibers can be present in the antenna as filaments; or the stainless steel fibers can be present in the antenna as fibers of discrete length. With filaments is meant stainless steel fibers of virtually unlimited length. An metal cable comprising stainless steel filaments can be provided as a bundle of twisted parallel filaments, or as multiply (e.g. a two-ply) twisted or cabled yarn. With fibers of discrete length is meant that the fibers have a finite length and in most cases a length distribution. Antenna yarns out of fibers with discrete length can be made by means of a yarn spinning process, e.g. ring spinning. Metal wire or cable out of fibers with discrete length can be single ply yarns, or multiply (e.g., two ply) yarns.

Stainless steel fibers for use in the invention, whether filaments or fibers of discrete length, can be made according to the bundle drawing method, as is e.g., described in US-A-2050298. Bundle drawn fibers have a characteristic polygonal cross-section. Preferably, bundle drawn stainless steel fibers for use in the invention have an equivalent diameter of more than 4 μm, preferably of more than 10 μm; and preferably less than 30 μm, more preferably less than 20 μm; more preferably less than 15 μm.

It is also possible to use in the invention single end drawn stainless steel filaments. Such filaments have in most cases a round cross section. Preferred are single end drawn stainless steel filaments with cross section more than 40 μm and preferably less than 100 μm, e.g. 50 μm, 60 μm or 80 μm. An example is a cable consisting out of 24 stainless steel filaments of 50 μm diameter twisted together with 100 turns per meter.

The composite structure according to the invention has a “helixed” structure, which comprises a textile core with metal wires or cable spiraled in a defined pattern around the textile core. As an example, the “defined pattern” can be defined so that the metal wires or cables can wrap around the textile core with a defined fixed pitch length. As an example, the pitch length can be in a range between 0.1 to 5 cm, preferably in a range between 0.5 to 3 cm, and most preferably in a range between 0.8 to 2 cm. Alternatively, the textile core can be fully covered with metal wires or cables. Moreover, the metal wires or cables can be in form of strip, i.e. a plurality of wires or cables next to each other to form a strip. Such a strip of metal wires or cables can wrap around the textile core with a fixed defined pitch length. The strip form can be maintained during proceesing and there is no crossing point or overlapping of metal wires or cables. It is designed in such a way that the textile core absorbs most of the stresses that the final product can undergo, in other words, it increases the mechanical performance of the final product. These stresses are mainly tensile stresses, stresses due to twisting, stress due to pressure, stresses due to bending . . . The structure can also have some ‘anti-slippery’ properties to have correct spiraling of the metal antenna wire.

The metal wire or cable is provided to fulfil the antenna function in the antenna. The metal wire or cable which is “helixed” around the central textile core is ideally a very durable, corrosion resistant wire/multifilament cable with a good reading performance in radiofrequency spectrum.

It has been noticed that the metal wire or cable can cause a compaction of the textile core, reducing its diameter. The wrapping metal wire or cable in itself is thin as well. The compaction is even more present when using a textile core with low twist (low twist: e.g., less than 200 turns per meter, or even less than 150 turns per meter, or even less than 120 turns per meter) or when using a textile core without twist. Low twist textile core or textile core without twist have certain voluminosity. The metal wire or cable compresses and compacts the textile core.

The composite structure is wrapped by at least one wrapping layer thereby covering the full surface of the core, of the metal wire or of the metal cable. The at least one wrapping layer comprises-and preferably consists out of-non-electrically conductive material. The at least one wrapping layer wrapping the composite structure creates an alternative electrical insulation of the antenna compared to the prior art extrusion coated antennas. It is a beneficial technical effect of the use of the at least one wrapping layer that a thinner antenna with lower bending stiffness can be obtained compared to the prior art version antenna which is extrusion coated. In extrusion coating, a certain minimum coating thickness is required in order to ensure that the full antenna surface is covered with insulation coating. This is especially important when the antenna yarn has an irregular surface; the full surface needs to be coated. The result after extrusion coating is a rather thick antenna. Furthermore, the wrapping layer result in much less increase of the bending stiffness compared to coated antennas. The protective sleeve makes sure the metal wire or cable is electrically insulated, it adds an additional protection to the metal antenna cable and increases the adherence to the embedded system (rubber, epoxy, composite . . . ) probably by having higher specific surface that can be used to increase adhesion. The protective sleeve structure will also absorb any stresses formed by elongation, bending, pressure . . . The composite structure can have a diameter between 0.25 and 0.45 mm, while the antenna with protective sleeve can have a diameter in a range of 0.30 mm to 0.70 mm.

According to the present invention, the protective sleeve can consist of one or more wrapped layers of textiles. These textile wraps can be done in both S, Z direction or a combination of S and Z direction. The textile can be-but not exclusively-any textile, ranging from polymer-based yarns, wires, multifilaments, monofilaments . . . of i.e., polyester, polyamide, polyimide, (para-or meta-) aramid, LCP, Kevlar®, . . . but also organic materials in yarns, wires, multifilaments, monofilaments of i.e., cotton, hemp et al.

The diameter range of the used material for protective wrapping is anything from 0.10 mm to 0.30 mm, corresponding to a dtex range from 110 to 2000 dtex, depending on the properties of the textile used, increasing the diameter of the finale product to maximum 0.70 mm. Each of the at least one wrapping material can be wrapped around the composite Structure with more than 1000 turns per meter length of the antenna.

The protective sleeve of antenna can be coated with a rubber-to-metal adhesive or Resorcinol Formaldehyde Latex (RFL), e.g., under trademark Chemlok The adhesive can be a mixture of polymers, organic compounds, and mineral fillers dissolved or dispersed in an organic solvent system.®. the adhesive is to build a Rubber-To-Metal Adhesive System.

As an example, the wrapping yarn or wrapping yarns is/are a multifilament yarn or is/are a spun fiber yarn or is/are monofilament. Preferred multifilament wrapping yarns are texturized multifilament yarns, e.g., polyester multifilament yarns. More preferred are non-entangled texturized multifilament yarns because they provide best coverage.

Preferably, each of the at least one wrapping yarn is wrapped around the antenna yarn with more than 1000 turns per meter length of the composite structure; more preferably with more than 2000 turns per meter length of the composite structure. The wrapping yarn or wrapping yarns can e.g., be one or more than one tape.

In a preferred embodiment, the at least one wrapping yarn is at least one tape. A tape is a particular type of monofilament yarn: a tape has a cross section that is substantially flat, showing a thickness and a width. For the invention, tapes are used that preferably have a width over thickness ratio of the cross section of at least 10, preferably at least 15. Preferably, the width over thickness ratio of the tapes is lower than 50, more preferably lower than 35. Preferred is where the windings of the tape are not overlapping, but touching each other in subsequent turns of wrapping. Such tapes in polyester, polyamide, polyolefin (e.g. polyethylene or polypropylene) can be used. Polyester tapes are preferred however, thanks to their interesting combination of properties. Preferred tapes have a cross section with a thickness between 10 and 40 micrometer, more preferably between 10 and 25 micrometer, even more preferably between 12 and 25 micrometer. Preferably the width of the cross section of the tape is at least 100 micrometer, more preferably at least 200 micrometer, even more preferably at least 300 micrometer. Preferably the width of the tape is less than 500 micrometer. Specific examples of cross sections of tapes that can be used in the invention are e.g., 250 micrometer by 12 micrometer, 350 micrometer by 12 micrometer, 370 micrometer by 12 micrometer and 250 micrometer by 23 micrometer, e.g. in polyester.

The direction of wrapping of yarns is indicated by the capital letters S or Z. The wrapping is in S-direction if when the wrapped yarn is held vertically, the wrapping spirals slope in the same direction as the middle portion of the letter S. The wrapping is in Z-direction if when the wrapped yarn is held vertically, the wrapping spirals slope in the same direction as the middle portion of the letter Z.

As an embodiment, the composite structure is preferably wrapped by a wrapping yarn in S-direction. More preferably, the composite structure is wrapped in S-direction by a multifilament wrapping yarn, more preferably by a texturized multifilament wrapping yarn, more preferably by a non-entangled texturized multifilament wrapping yarn. More preferably, the composite structure is wrapped in S-direction by a multifilament wrapping yarn with more than 1000 turns per meter length of the composite structure, more preferably with more than 2000 turns per meter length of the composite structure. Preferably, the composite structure is wrapped by a wrapping yarn in Z-direction. More preferably the composite structure is wrapped in Z-direction by a multifilament wrapping yarn, more preferably by a texturized multifilament wrapping yarn, more preferably by a non-entangled texturized multifilament wrapping yarn. More preferably, the composite structure is wrapped in Z-direction by a wrapping yarn with more than 1000 turns per meter length of the antenna yarn, more preferably with more than 2000 turns per meter length of the antenna yarn.

In a preferred antenna, the composite structure is wrapped by a wrapping yarn in S-direction; and the composite structure is wrapped by a wrapping yarn in Z-direction. In such embodiments the wrapping yarns can each be a tape. Preferably, the number of turns per meter length of the wrapping in S-direction is the same as the turns per meter length of the wrapping in Z-direction. The composite structure can be wrapped by the wrapping yarns with more than 1000 turns per meter length of the antenna. More preferably, with more than 2000 turns per meter length of the antenna. A way of wrapping in Z-and in S-direction around the axis of the composite structure is by wrapping part of the wrapping yarns in S-direction and part of the wrapping yarns in Z-direction around the axis of the composite structure. The advantage of embodiments as described is that a more stable antenna is obtained. Preferably, the antenna contains the same amount of wrapping yarns wrapping in S-direction as in Z-direction, as the result is the best stability of the antenna and as it enhances the coverage of the composite structure. For instance, the metallic filament is wrapped by an even number of wrapping yarns, wherein half of the wrapping yarns is wrapped around the metallic filament in S-direction and the other half in Z-direction. The benefit is a stabilization of the antenna.

The second aspect of the invention is an RFID tag comprising a transponder chip and an antenna as in the first aspect of the invention. The antenna is coupled to the transponder chip. The antenna can be inductively coupled to the transponder chip.

Preferably, the RFID tag comprises a transponder chip and two antennas as in the first aspect of the invention. For instance, the two antennas are each coupled to the transponder chip; the antenna can be inductively couple to the transponder chip. Preferably, the included angle between the two antennas is 180°.

A third aspect of the invention is an assembly of a pneumatic rubber tire for a motorized vehicle and an RFID tag as in the second aspect of the invention. The RFID tag comprises a transponder chip and an antenna according to the present invention, wherein the antenna is coupled to a transponder chip. The protective sleeve of the antenna of the RFID is embedded into pneumatic rubber. Due to wrapping process, the protective sleeve is not firmly attached to the helix structure, but firm enough to hold onto the helix structure. This way of construction of the sleeve makes it possible to have protective properties during stress conditions. Because of the properties of the sleeve (due to the characteristics of the textile wrap), a good adhesion between the sleeve and the embedded system can be obtained. This is in such way that the embedded system does not adhere to the metallic wire/cables and thus only ‘adheres’ with the sleeve. The inventive RFID antenna cable is electrically insulated via protective sleeve so that the RFID tag can be immediately integrated into the tire without having been covered by nonconductive material and does not need to be before hand pouched into e.g. a non-conductive rubber.

The RFID tag of the present invention can have a carrier or substrate, that facilitate the processing of RFID, e.g., embedded into pneumatic rubber. The transponder chip can e.g., be fixed onto a textile fabric (as carrier or substrate) by means of a laminating foil, or by means of epoxy blob, or by means of glue. The antenna or antennas can be fixed onto the textile fabric by means of one or more stitching yarns. The inventive antenna is developed for mechanically or inductively coupled RFID solutions.

Preferably the RFID-tag is fixed onto the textile fabric such that the antenna forms on the textile fabric a loop with overlapping ends. The transponder chip can be present on the fabric inside the loop with overlapping ends.

Preferably, the antenna is fixed onto the textile fabric, so that the antenna undulates on the textile fabric. Preferably, the antenna is fixed onto the textile fabric by means of one or by means of more than one stitching yarns.

### BRIEF DESCRIPTION OF FIGURES IN THE DRAWINGS

FIG. 1 shows the cross section of an antenna for an RFID tag according to the first aspect of the invention.

FIG. 2 shows the section in a plane through and along the axis of an antenna for an RFID tag according to the first aspect of the invention.

FIG. 3 shows a textile fabric and an RFID tag fixed onto the textile fabric.

### MODE(S) FOR CARRYING OUT THE INVENTION

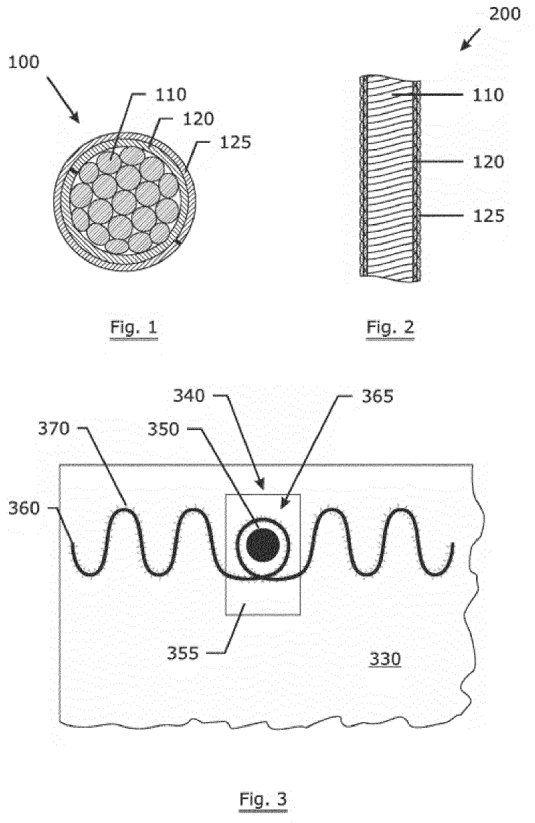

FIG. 1 shows the cross section 100 of an exemplary antenna for an RFID tag according to the first aspect of the invention. FIG. 2 shows the section 200 in a plane through and along the axis of an exemplary antenna for an RFID tag according to the first aspect of the invention.

The exemplary RFID-antenna has been made using high-performance multifilament yarn spun from liquid crystal polymer, e.g. under trademark Vectran® or Para-aramid filaments, e.g. under trademark Taparan®, as the textile core 110. Preferably, the core has a liner density of 440 dtex. The core is wrapped by bundle drawn stainless steel filaments of 12 um equivalent diameter out of 316L stainless steel according to ASTM A240. A parallel bundle of 275 stainless steel filaments has been twisted with 100 turns per meter in order to obtain a twisted yarn. A twisted yarn 120 is wrapped in S-direction or Z-direction around the core 110 to form a composite structure.

The composite structure is insulated by a protective sleeve 125 made by polyester. Preferably, polyester yarn having a liner density of 76 dtex or 167 dtex is applied. More preferably two wraps are applied. The composite structure is wrapped in S-direction and in Z-direction by 76 dTex (=7.6 Tex) non-entangled texturized polyester multifilament yarns. The wrappings are done with 2250 turns per meter length of the antenna. The wrapping non-entangled texturized polyester multifilament yarns cover the full surface of the composite structure.

FIG. 3 shows a substrate, e.g., textile fabric 330 and an RFID tag 340 fixed onto the textile fabric. The RFID tag 340 comprises a transponder chip 350 and an antenna 360 as in the first aspect of the invention. The antenna 360 is positioned undulating on the textile fabric and forms in the middle of its length a loop 365 with overlapping ends. The antenna 360 is inductively coupled to the transponder chip 350. The RFID tag 340 is fixed onto the textile fabric substrate. The antenna 360 is fixed onto the textile fabric 330 by means of one or more than one stitching yarn 370. The transponder chip 360 is fixed onto the textile fabric by means of an, e.g., transparent, laminating foil 355. Alternatively, the transponder chip can e.g., be fixed onto the textile fabric by means of epoxy blob or glue.

The above RFID tag was embedded into pneumatic rubber and presented an improved bending and fatigue life.

In the example, 316L stainless steel fibers have been used; however, other stainless steel grades can be used in the invention.

Instead of non-entangled texturized multifilament wrapping yarns, other yarns or tapes can be used as wrapping fiber material for protective sleeve.

Although protective sleeve wrapping in S-and in Z-direction is preferred, wrapping in only one direction (S or Z) can be used in the invention.

1. An antenna for use in an RFID tag, said antenna comprising a core, a metal wire or cable, and a protective sleeve,
wherein said core comprises, and preferably consists of, textile made from polymer or organic materials,
said metal wire or cable is spiralled or helixed around said antenna core in Z or S direction to form a composite structure, and
said protective sleeve is made by one or more wrapped layers around said composite structure, and said protective sleeve comprises, and preferably consists of, textile made from polymer or organic materials.

2. The antenna for use in an RFID tag according to claim 1, wherein the textile of the core or the protective sleeve is in a form of yarns, wires, multifilaments, or monofilaments.

3. The antenna for use in an RFID tag according to claim 1, wherein the core or the protective sleeve comprise polymer selected from polyester, polyamide, polyimide, (para- or meta-) aramid, or Liquid Crystal Polymer (LCP).

4. The antenna for use in an RFID tag according to claim 1, wherein the core or the protective sleeve comprise organic materials selected from cotton or hemp.

5. The antenna for use in an RFID tag according to claim 1, wherein the textile core has an equivalent diameter in a range from 0.10 mm to 0.30 mm and/or has a linear density in a range from 110 dtex to 2000 dtex.

6. The antenna for use in an RFID tag according to claim 1, wherein the metal wire or cable is made from stainless steel, etched copper, or aluminium.

7. The antenna for use in an RFID tag according to any one of the claim 1, wherein the metal cable is made from a plurality of monofilaments with a diameter of more than 25 μm or from a bundle of ultrafine wires with a diameter less than 25 μm.

8. The antenna for use in an RFID tag according to claim 1, wherein the composite structure has a diameter between 0.25 and 0.45 mm.

9. The antenna for use in an RFID tag according to claim 1, wherein the antenna has a diameter in a range of 0.30 mm to 0.70 mm.

10. The antenna for use in an RFID tag according to claim 1, each of the at least one wrapping material is wrapped around the composite structure with more than 1000 turns per meter length of the antenna.

11. The antenna for use in an RFID tag according to claim 1, wherein the protective sleeve is coated with a rubber-to-metal adhesive or Resorcinol Formaldehyde Latex (RFL).

12. An RFID tag comprising a transponder chip and the antenna according to claim 1, wherein the antenna is mechanically or inductively coupled to the transponder chip.

13. A pneumatic rubber tire for a motorized vehicle comprising the RFID tag according to claim 12, wherein the protective sleeve of the antenna of the RFID is embedded into pneumatic rubber.
